(19) United States
(12) Patent Application Publication
(10) Pub. No.: US 2017/0183216 A1
(43) Pub. Date: Jun. 29, 2017

(54) adjustablesaddleseatforhorsesaddle

(71) Applicant: David Graham Kaden, Canutillo, TX (US)

(72) Inventor: David Graham Kaden, Canutillo, TX (US)

(21) Appl. No.: 14/982,946

(22) Filed: Dec. 29, 2015

(51) Int. Cl. B68C 1/04; B68C 1/02

(52) U.S. Cl. CPC B68C 1/04; B68C 1/025; B68C 2001/044

(57) ABSTRACT

A method of changing the angle of the seat of a saddle used for riding horses. This invention requires a removable or detachable seat cover under which is a flexible seat, front of which may be raised or lowered for maximum rider comfort. This is achieved by using spacers under the front of the seat structure, which is called a ground seat, in saddle making nomenclature. This invention allows saddle seat configuration to be optimized for different riding conditions or disciplines, which traditionally use saddles that have differing seat angles, to optimize rider position and comfort for that discipline.

### TECHNICAL FIELD

The present invention is generally related to enhancement of the comfort and function of a Horse saddle. It utilizes an innovative and unorthodox method of saddle seat construction so as to provide access to the seat foundation, in order to be able to modify the angle and shape of the saddle seat.

### BACKGROUND OF THE INVENTION

The use of a horse to accomplish a variety of task often involves riding at different speeds, and utilizes varying types of stops and turns. This has lead to development of saddle seats that vary according to the primary use of a particular horse and its saddle. A rider who rides a saddle on a gaited horse like a Tennessee walker generally prefers a saddle seat that tilts the rider back slightly. This is achieve by sloping the seat toward the rear. This will favor a saddle with more rise in front of the seat so the riders' seat is cradled in a deeper pocket with a seat in more of a dip shape under riders' seat. Conversely a pleasure rider who is riding cross country at some speed using a trot or canter (aka gallop) as in the sport of endurance racing, will be more comfortable in a flatter seat configuration that allows him or her, to “post” rising and falling in such a way as to absorb the movement of the horse to reduce impact on his or her body for long periods of time. This type of horse “gait” or style of footfall of the horse, is more bouncy than that of a gaited horse, and thus riders want to lift themselves off the horse rather than sit as riders of gaited horses do.

Another factor influencing seat design involves the riders' skill level. A Novice or inexperienced rider finds the deeper pocket with front rise holds him in place and provides a sense of security. A more experienced rider often fords this seat style restrictive to the skilled riders' movements, which reduce shock and vibration associated with riding a horse while trotting or cantering.

Another application of this adjustable seat invention, is for use with so called “down hill” horses, whose front legs are shorter than their hind. Riding horses built like this in traditional saddle seats makes the rider feel like they to a sitting downhill and tipping forward. The ability to raise the saddle seat will be of benefit to riders of horses with this body style, which are becoming increasingly prevalent.

The variety of differing saddles used for different horse sports has evolved to facilitate these differing activities, but renders saddles discipline specific.

To make a particular saddle more flexible in its use and more comfortable for riders of varying abilities, the invention described herein allows the seat to vary so as to optimize rider position for that type of activity and or to accommodate the confirmation of their horse's body style.

### SUMMARY OF THE INVENTION

The invention allows a rider of a horse saddle to adjust the seat of the saddle so as to enhance the balance and comfort of the rider. This is influenced by the type of riding and speed or gait which the rider most commonly rides the horse in.

This adjustment is achieved by a constructing a sea so as to allow removal of the cover of the seat so expose the underlying structure of the seat. This seat cover may be attached by hook and loop fastening system, such as that sold under the trademark VELCRO, or Screws, or a combination of the two. Padding is built into this removable seat, so as to enhance comfort for the rider.

A special underlying flexible structure, has been developed so as to allow the rider to change the angle of the seat structure. This element which supports the seat covering be it leather or other material is commonly referred to as a ground seat.

This invention uses a plurality of spacers thru which a bolt or screw is inserted into the saddle tree below. This method of adjustment may be achieved by either raising, or lowering either the front, or the rear of the seat supporting structure (aka ground seat) so as to change the angle of the seat. The preferred embodiment involves movement of the front while rear remains attached. This movement is achieved thru the use of a flexible material in the ground seat element. Use of a more rigid ground seat is also contemplated as an embodiment of the invention, which would involve a localized hinge or other form of flexible joint so as to allow repositioning of the ground seat in such a way as to change the height and associated angle of the saddle seat which it supports.

### DESCRIPTION OF THE DRAWINGS

Many aspects of the invention can be better understood with reference to the following drawings. These four figures are shown in three pages. The components in the drawings are not necessarily to scale, emphasis instead being placed upon clearly illustrating the principles of the present invention.

FIG. 1. Representation of typical removable spacers used to raise the saddle seat in front.

FIG. 2. Side view of the saddle with inserts removed so seat angle is more horizontal.

FIG. 3. Font view of inserts installed and attachment screws, and bushing associated with adjustment method. Also shown is the padded removable seat cover

FIG. 4. Front view showing all interacting components including the spacers, flexible ground seat, padded seat cover, attachment screws and associated bushings installed into saddle tree bars.

### DETAILED DESCRIPTION OF THE PREFERRED EMBODIMENT

The Invention refers to a method and apparatus for customizing a horse riding saddle seat angle so as to enhance comfort and security of the rider. In one embodiment the seat structure known as a ground seat, is made of a flexible plastic material and allows permanent attachment at it's rear part to the saddle tree seat, and is flexible in the middle, so that the front may be raised resting on inserts of varying height. This allows the rider to choose the spacer that most comfortably fits their riding style. An additional benefit is that seat is more level when used on a horse whose hind end is higher than front end and thus their back slopes forward.

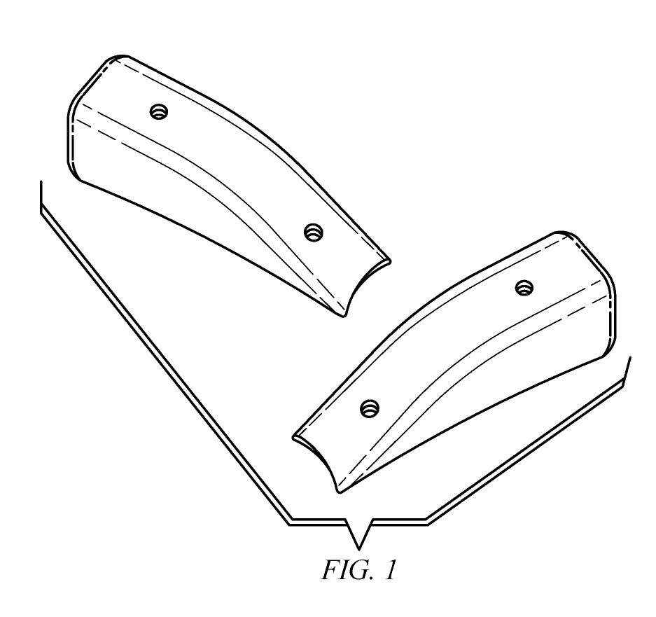

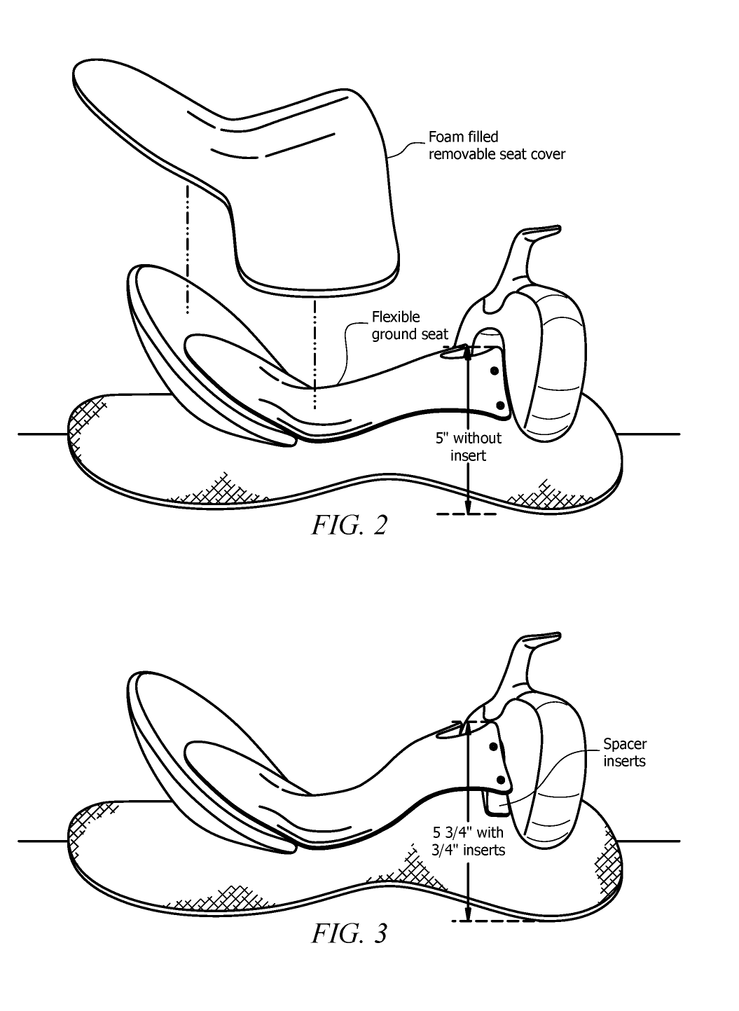

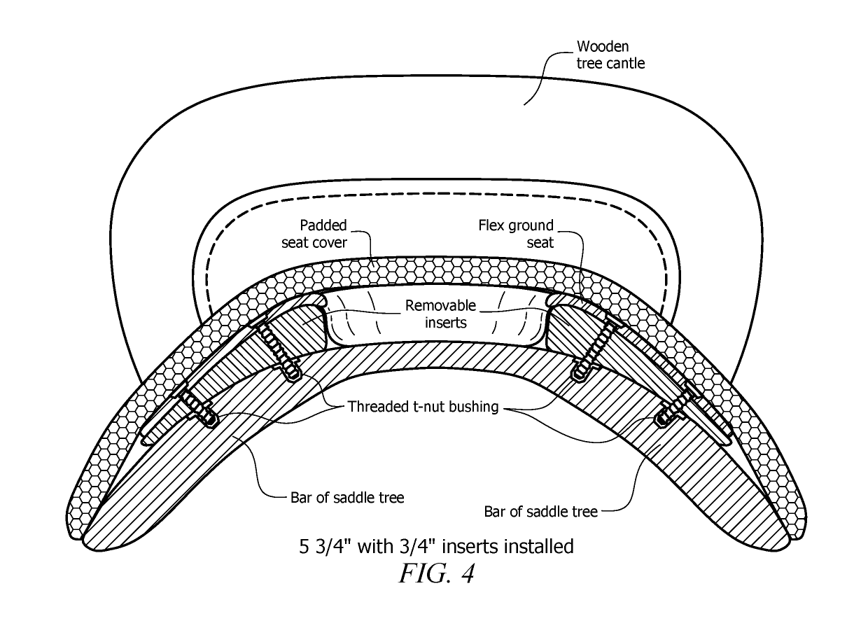

The spacers are shown (which are to be attached under the ground seat of the tree), is show in FIG. 1.

The ground seat may be lowered by removing the spacers as shown in FIG. 2, and a shorter screw is put directly into the bushing without any insert.

Spacers may be made of layers of leather glued together with a central hole, or they may be made of metal or plastic. The varying thickness of the spacers controls the height raise of the seat, and these spacers may take many different forms and anything used to fill space between seat structures aka ground seat, and underlying saddle tree, shall be covered under this patent application.

The access to the ground seat is achieved by a removable padded seat cover made of leather, or nylon or other material and may or may not have a layer of foam added for padding. This seat cover may be attached by a variety of fasteners including but not limited to Hook and Loop aka Velcro, screws, or bolts or other fastening systems and allow detachment and reattachment of the seat cover.

The spacers may be several in number and varying size so as to offer a variety of angles and associated heights of ground seat front. The Invention may utilize screws or bolts of varying lengths so as to accommodate inserts of varying thickness.

Of course those skilled in the art will realize that other applications of the method and apparatus disclosed here but not described in detail, still remain within the scope of the present invention.

The present invention may be embodied as an apparatus, a method of manufacture or any combination thereof. Other variations and modifications of the present invention will be apparent to those of ordinary skill in the art and is not limited except by claims.

### GLOSSARY

Saddle tree; a structure composed of bars and cantle (rear of seat) and pommel (front structure) that are the internal frame of a riding saddle.

Ground seat. The element which supports a saddle seat and spans the bars of the saddle tree. This is made of a plastic material in the present invention so as to be flexible to allow angle adjustments.

Bushings, are metal sleeves into which threaded bolts or screws are inserted to enhance strength and durability these are inserted into a hole in bar of saddle tree.

It should be emphasized that the above-described embodiments of the present invention, particularly any ‘preferred” embodiments are merely possible examples of implementation, merely set for a clear understanding of the principles of the invention. Many variations and modifications may be made to the above described embodiments of the invention without departing substantially from the sprit and principles of the invention. All such modifications are protected by the following claims.

Therefore, having thus described the invention at least the following is claimed:

1. A riding saddle having a seat that is adjustable with respect to front to rear axis, or slope, comprising;
A. A removable seat cover, covering a seat structure called a ground seat. which is affixed to a saddle tree.
The underside of the front of the ground seat rest on removable spacers. These spacers are of varying thicknesses so as to raise or lower the front of the saddle seat.
This provides for varying slope or angles of the saddle seat. These spacers may be composed of varying material, including leather, plastic or other.
B. The ground seat of claim one is made of a strong but flexible material allowing the front to be raised or lowered while rear portion of ground seat is permanently attached.
C. The ground seat of claim 1 is raised or lower in the rear, with spacers under the rear of ground seat with front of ground seat remaining attached, so as to effect change in the seat angle for the benefit of rider comfort and security.
D. The riding saddle of claim 1 includes a removable seat cover so as to provide Access to the ground seat and associated adjustment apparatus.

2. The ground seat of claim one is detachable and removable and to be replaced with other ground seats of differing slope and angle with spacers permanently affixed to the ground seat in such a way as to change seat angle.

3. The padded seat of claim 1 is made of varying thickness especially in front area so as to effect the angle of seat, similar to the effect of spacers under the ground seat.
